(19) United States
(12) Patent Application Publication
(10) Pub. No.: US 2006/0236530 A1
(43) Pub. Date: Oct. 26, 2006

(54) Device for assembling substrates with electronic components

(75) Inventor: Walter Andersch, Kirchheim (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 10/546,260

(22) PCT Filed: Dec. 5, 2003
(86) PCT No.: PCT/DE03/04007

§ 371 Date: Aug. 22, 2005

(30) Foreign Application Priority Data
Mar. 6, 2003 (DE) 103 09 879.8

(51) Int. Cl. B23P 19/00

(52) U.S. Cl. 29/740; 29/742; 29/743; 414/737; 29/719

(57) ABSTRACT

The present invention relates to a picking arm which may be displaced along a stationary longitudinal guide. A picking head for electrical components may be displaced along a transverse guide on the picking arm by a linear motor. A support for the picking arm embodied as a box-like hollow body is made from plastic reinforced with carbon fiber. The transverse guide and a stator for the linear motor are arranged on a lateral wall of the support. The lateral wall is reinforced by reinforcing elements against local deformations which are caused by the magnetic forces of the linear motor.

The invention relates to a device for mounting electronic components on substrates by means of a placement head that can be moved in one operating plane, a positioning arm movable in a stationary longitudinal guide having a linear transverse guide for said placement head.

A pick and place machine of this kind is known from WO 9837744 A, according to which the freely extending positioning arm of beam-like construction is anchored at one end to a base section which can be moved in a stationary longitudinal guide by means of a linear motor whose mobile part is incorporated in the base section. The positioning arm extending perpendicularly to the longitudinal guide additionally has a transverse guide in which a revolver-type placement head can be moved. It was hitherto usual for a head of this type to be moved by means of a toothed belt driven in the base section. The longitudinal guide and the transverse guide form an operating plane in which the placement head can be moved between feed modules for the components and a circuit board fixed in a placement area in order to be able to place the components taken from the feed modules at precise locations on the circuit board.

In order to achieve high placement rates, the positioning arm is accelerated and braked at up to 4 times gravity. Particularly when the placement head is at the outer end of the steel positioning arm, the latter is strongly deflected. The vibrations caused thereby must decay sufficiently before the component can be placed accurately on the circuit board, which entails a corresponding delay.

The object of the invention is to increase the placement rate.

This object is achieved by the invention according to claim 1. The CFP material used has a specific gravity of approximately ⅕ the specific gravity of steel. As the modulus of elasticity is only slightly less than that of steel, the positioning arm can be made much more rigid with a larger cross section and lower weight, thereby considerably reducing the vibration amplitude and decay time.

By using a linear motor for driving the placement head, the motion in this direction can be controlled considerably more rapidly and precisely, thereby increasing the placement rate still further. However, a problem is posed here by the magnetic pull forces exerted between the placement arm and the placement head. Although these relatively high magnetic forces are checked by lateral support bearings of the linear guide, they cause local deformation of the support which could additionally adversely affect the positioning accuracy. The reinforcing elements stiffen the side wall in such a way as to minimize the deformation caused by the magnetic forces.

Advantageous developments of the invention are set forth in claims 2 to 9.

The linear motor guided on the positioning arm has the disadvantage that the operating heat developed by the coil section heats up the positioning arm, causing differential expansion between the CFP material and the guide rails of the linear guide and the magnet rail. This bimetallic effect therefore produces bending deformation of the positioning arm which can have a severely adverse effect on positioning accuracy. Effective cooling of the coil section enables a large part of the resulting heat to be removed and in particular the operating temperature of the linear motor to be considerably reduced so that the effect on the positioning arm can be neutralized.

The development according to claim 3 has the advantage that the placement head can be mounted directly on the coil section in a space-saving manner and that the bias produced by the magnetic forces allows defined, backlash-free guidance which is also transmitted directly to the placement head. The cooling of the interspace prevents the operating heat of the coil section from being transferred to the placement head.

By means of the second linear motor according to claim 4, the positioning arm is guided with low backlash on the chassis of the pick and place machine in a space-saving arrangement and using the magnetic bias. The linear motor allows extremely easy and precise adjustment. Due to the fact that the side wall extends in a continuous straight line to the longitudinal guide, the placement head can be moved right up to the guide rails of the longitudinal guide using the entire length of the positioning arm, thereby enlarging the operating plane accordingly.

The support according to claim 5 is of simple, weight-saving and dimensionally stable design.

The support according to claim 6 can be composed of simple elements with low device complexity. The reinforcing elements used in a framework manner are braced between the side wall supporting the linear motor and the opposite back wall and stiffen the placement arm in this direction. As the reinforcing elements can be attached to the inside of the side wall over the entire width, they also stiffen the latter against the local deformations produced by the magnetic forces.

The development according to claim 7 allows the use of reinforcing elements which are of uniform size over the entire length of the positioning arm and are for example adhesively attached to the side wall.

By means of the spring elements according to claim 8, differential spacing between the guide rails and the guide elements is eliminated, thereby preventing distortions between the guide elements and guide rails.

The invention will now be explained in greater detail with reference to an exemplary embodiment illustrated in the accompanying drawing.

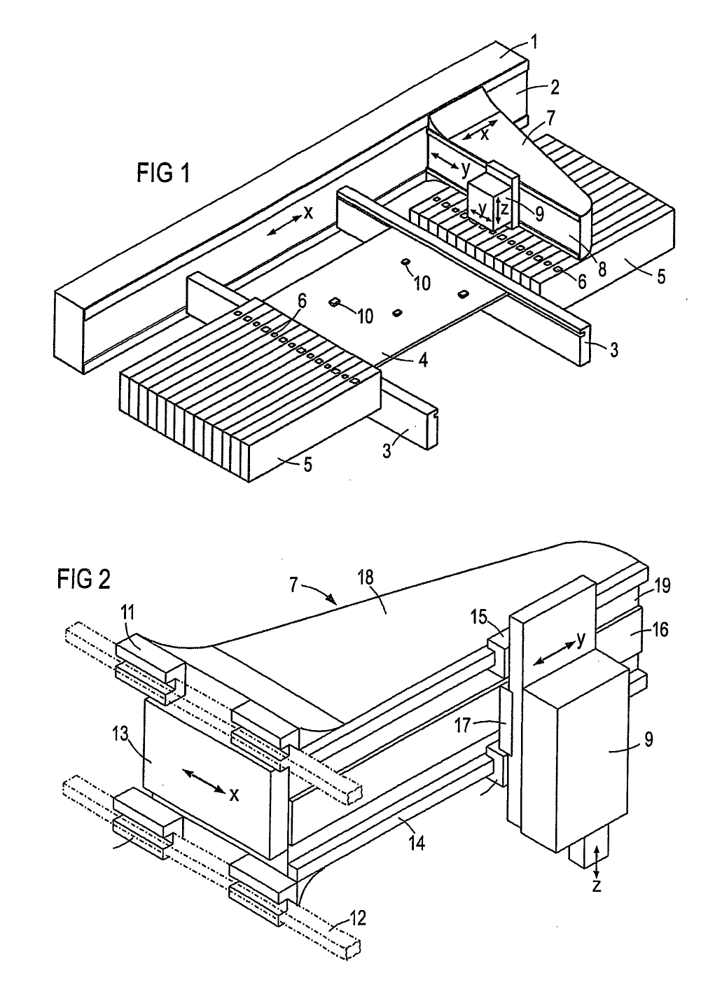

According to FIG. 1, a beam-like chassis section 1 has a horizontally running linear longitudinal guide 2 which extends in a coordinate direction X. Adjacent to the chassis section 1 is a table 3 on which a substrate 4 implemented as a circuit board is fixed. On both sides of the table there are disposed feed modules 5 for electronic components 10, the pick-up locations 6 of which are arranged perpendicularly to the longitudinal guide 2. On the longitudinal guide 2 there is guided a positioning arm 7 movable in the X-direction which extends freely perpendicularly from the longitudinal guide 2 and which has a horizontal transverse guide 8 perpendicular to the longitudinal guide 2 and in which a placement head 9 can be moved in a Y-direction.

The various electronic components 10 to be picked up by the placement head 9 are provided at the pick-up locations 6 of the feed modules 5. The pick-up locations 6 and the substrate 4 are virtually in a single plane with respect to which the grippers can be moved up and down in a vertical Z-direction.

The placement head 9 can be moved within the operating plane formed by the X- and Y-axis between the pick-up locations 6 and the placement locations of the components 10 on the substrate 4, the precise operating positions being set by the corresponding positioning of the positioning arm in the longitudinal guide 2 and of the placement head 9 in the transverse guide 8.

FIG. 2 illustrates in greater detail the positioning arm 7 with its guides, drives and the placement head 9. On its base section, the positioning arm 7 has guide elements 11 which engage with parallel guide rails 12 of the stationary longitudinal guide 2 (FIG. 1). Between the guide elements 11 there is disposed a mobile section 13 of a second linear motor whose magnet rail (not shown) is continuously attached to the chassis section 1 between the guide rails 12. The positioning arm 7 can be moved quickly and precisely along the guide rails 12 by the linear motor.

On the positioning arm 7 there are disposed perpendicularly to the guide rails 12 further guide rails 14 of the transverse guide 8 in which further guide elements 15 of the placement head 9 can be moved. Between the guide rails 14 there is additionally disposed a magnet rail 16 which together with a coil section 17 of the placement head 9 forms a first linear motor which drives the placement head 9. The positioning arm 7 has a box-like support 18 to which the mobile section 13, the guide elements 11 and, on a side wall 19, the magnet rail 16 and the guide rails 14 are attached. A rear side of the support 18 opposite the side wall 19 runs obliquely to the side wall 19 in such a way that the support 18 narrows from the base towards its free end.

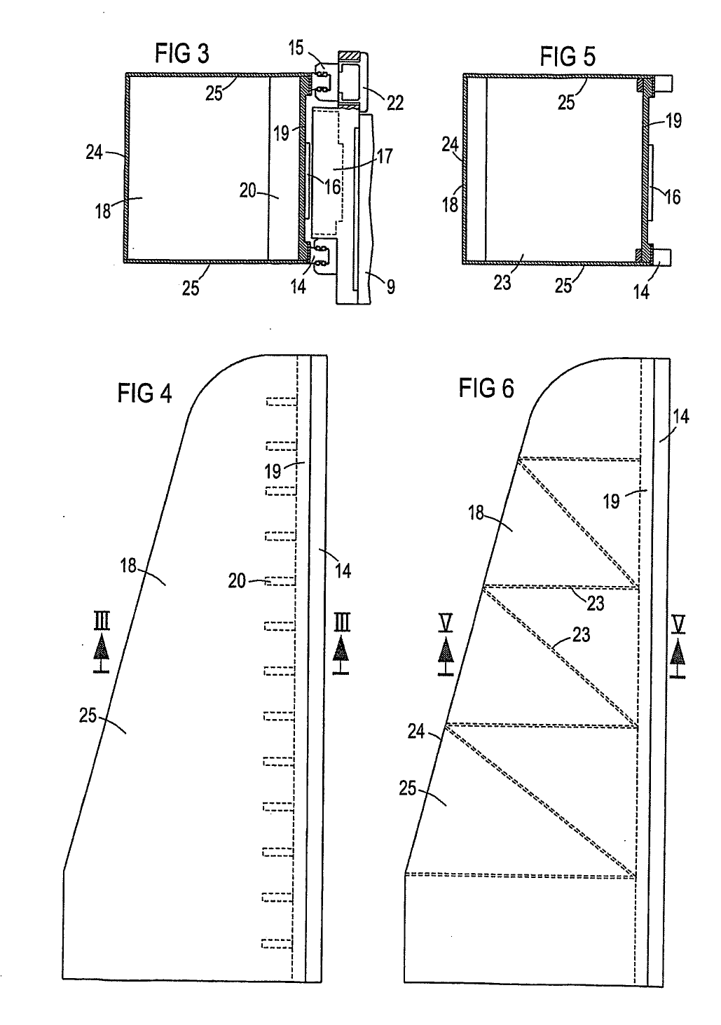

As shown in FIGS. 3 and 4, the support 18 is bonded together from individual sheets of carbon fiber reinforced plastic, commonly known as CFP. The cross-sectional view in FIG. 3 shows that the side wall 19 supporting the magnet rails 16 is of reinforced design and is additionally strengthened by rib-like reinforcing elements 20 disposed along the entire length of the side wall 19 and extending over the entire width of the side wall 19. Between the placement head 9 and the coil section 70 assigned thereto there is provided an interspace 21 through which a cooling medium can flow (in a manner not shown in greater detail) in such a way that a large part of the operating heat of the coil section 17 is dissipated. The guide elements 15 assigned to the lower guide rail 14 are rigidly connected to the placement head 9. The guide elements 15 assigned to the other guide rail 14 are connected to the placement head 9 via distance-compensating spring elements 22 which compensate, for example, thermally induced distance variations.

Between the side wall 19 and a back wall 24 opposite it there are disposed an upper and a lower connecting wall 25. The guide rails 14 are attached to the upper and lower edge respectively of the side wall 19 in immediate proximity to the connecting walls 25 which brace the guide rails 14 particularly effectively against deflection.

FIGS. 5 and 6 show the support 18 with modified plate-shaped reinforcing elements 23 which are combined in a framework manner inside the support 18 between the back wall 24 and the side wall 19 and reinforce it against the effect of the magnetic forces.

### REFERENCE CHARACTERS

1 Chassis section
2 Longitudinal guide
3 Table
4 Substrate
5 Feed module
6 Pick-up location
7 Positioning arm
8 Transverse guide
9 Placement head
10 Component
11 Guide element
12 Guide rail
13 Mobile section
14 Guide rail
15 Guide element
16 Magnet rail
17 Coil section
18 Support
19 Side wall
20 Reinforcing element
21 Interspace
22 Spring element
23 Reinforcing element
24 Back wall
25 Connecting wall

1. A device for mounting electronic components on substrates, comprising:
a placement head arranged to be moved in one operating plane,
a positioning arm movable in a longitudinal guide, the arm comprising, for the placement head, a linear transverse guide disposed perpendicularly to the longitudinal guide,
a hollow-construction support of the positioning arm, the arm comprising carbon fiber reinforced plastic, and arranged such that the placement head can be moved along the transverse guide by means of a first linear motor having a stator formed by a magnet rail and attached to the support and a mobile coil section permanently assigned to the placement head, and
a side wall of the support arranged to carry the magnet rails, the wall comprising reinforcing elements for directly checking the magnetic forces exerted between the magnet rail and the coil section.

2. The device according to claim 1, wherein the coil section comprises a cooling apparatus arranged to remove operating heat.

3. The device according to claim 2, wherein the placement head is mounted directly on a housing for the coil section such that a cooling medium can flow through an interspace between the coil section and the placement head.

4. The device according to claim 1, wherein the longitudinal guide is disposed on an end face of a freely extending positioning arm, the transverse guide is mounted on the side wall of the positioning arm extending in a continuous line to the longitudinal guide, the longitudinal guide is assigned a stator of a second linear motor, and the positioning arm has a mobile part of the second linear motor.

5. The device according to claim 1, wherein the support is implemented as a box beam narrowing towards its free end.

6. The device according to claim 4, wherein the support is bonded together from pre-shaped plate-like individual parts and the reinforcing elements are formed by intermediate plates attached to the side wall in a framework manner obliquely to the transverse guide.

7. The device according to claim 4, further comprising rib-like reinforcing elements disposed along the side wall.

8. The device according to claim 1, wherein at least one of the longitudinal guide and the transverse guide comprises two parallel guide rails on which guide elements of the positioning arm and placement head respectively are guided such that the guide elements assigned to one of the guide rails are permanently connected to the positioning arm and placement head respectively and such that the guide elements assigned to the other guide rail are connected to the positioning arm and placement head respectively via distance-compensating spring elements.

9. The device according to claim 8, wherein the guide rails are disposed in proximity to upper and lower connecting walls extending between the side wall and a back wall of the support.
